(19) United States
(12) Patent Application Publication
(10) Pub. No.: US 2010/0245279 A1
(43) Pub. Date: Sep. 30, 2010

(54) DISPLAY AND DISPLAY CONTROL SYSTEM FOR AN AUTOMATED LUMINAIRE

(75) Inventors: FRANTISEK KUBIS, POSTREDNI BECVA (CZ); MARTIN FRANIK, POSTREDNI BECVA (CZ)

Correspondence Address: HEINZ GRETHER PC;G2 Technology Law, P.O. Box 202858, AUSTIN, TX, 78720, US

(73) Assignee: ROBE LIGHTING S.R.O.

(21) Appl. No.: 12/749,681

(22) Filed: Mar. 30, 2010

Related U.S. Application Data
(60) Provisional application No. 61/165,293, filed on Mar. 31, 2009.

(51) Int. Cl. G09G 3/00; G06F 3/041

(52) U.S. Cl. 345/173; 345/30

(57) ABSTRACT

A display and control system for automated luminaires for easier and quicker service and usage monitoring.

### RELATED APPLICATION(S)

This application is a utility filing claiming priority of provisional application 61/165,293 filed on 31 Mar. 2010.

### TECHNICAL FIELD OF THE INVENTION

The present invention generally relates to an automated luminaire, specifically to the display and display control system within such a luminaire.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will typically provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern. The products manufactured by Robe Show Lighting such as the ColorSpot 700E are typical of the art.

FIG. 1 illustrates a multiparameter automated luminaire system. These systems commonly include a plurality of multiparameter automated luminaires 103, 104, 105 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 102, 106, 107 to one or more control desks 101. The luminaire system is typically controlled by an operator through the control desk 101.

FIG. 2 illustrates the display 110 of a prior art automated luminaire. Such a display and display control will typically comprise a number of push buttons 112 and an alphanumeric display 114. By using the push buttons 112 to scroll through and select menu items on the display 114 the operator may view and edit operational parameters of the automated luminaire such as its DMX512 start address, fan speeds, movement speeds and other configuration information. In other examples of the prior art it is also possible to use such systems to interrogate and display parameters such as operating temperatures, the number of hours the unit has had in operation, lamp hours and so on. With increasing sophistication and complexity of the automated luminaire these menu display and control systems have become very large and difficult to navigate and utilize and are constrained by the fixed layout of the push buttons and alphanumeric display. It would be advantageous to have a display system that was reconfigurable and flexible so as to match the desired functionality.

A further limitation of the prior art is that only a restricted number of parameters, such as lamp hours and fixture hours, are stored in non-volatile memory so that the information is not lost when the unit is powered off and most other parameters are lost. Further there is no way to access or interrogate any product failures or events leading to those failures. Such diagnostics would be helpful for both servicing and tracking the lifetime use of the products.

There is a need for an improved display and display control system for an automated luminaire which provides simple and reconfigurable access to utilize and interrogate the operational parameters of the luminaire and that further tracks and permanently stores operational, service and event data for recall and investigation at any time.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates a prior art display and display control system of an automated luminaire;

FIG. 3 illustrates a view of a display of an embodiment of the invention;

FIG. 4 illustrates a further view of a display of an embodiment of the invention

FIG. 5 illustrates a further view of a display of an embodiment of the invention

FIG. 6 illustrates a further view of a display of an embodiment of the invention

FIG. 7 illustrates a further view of a display of an embodiment of the invention

FIG. 8 illustrates a further view of a display of an embodiment of the invention

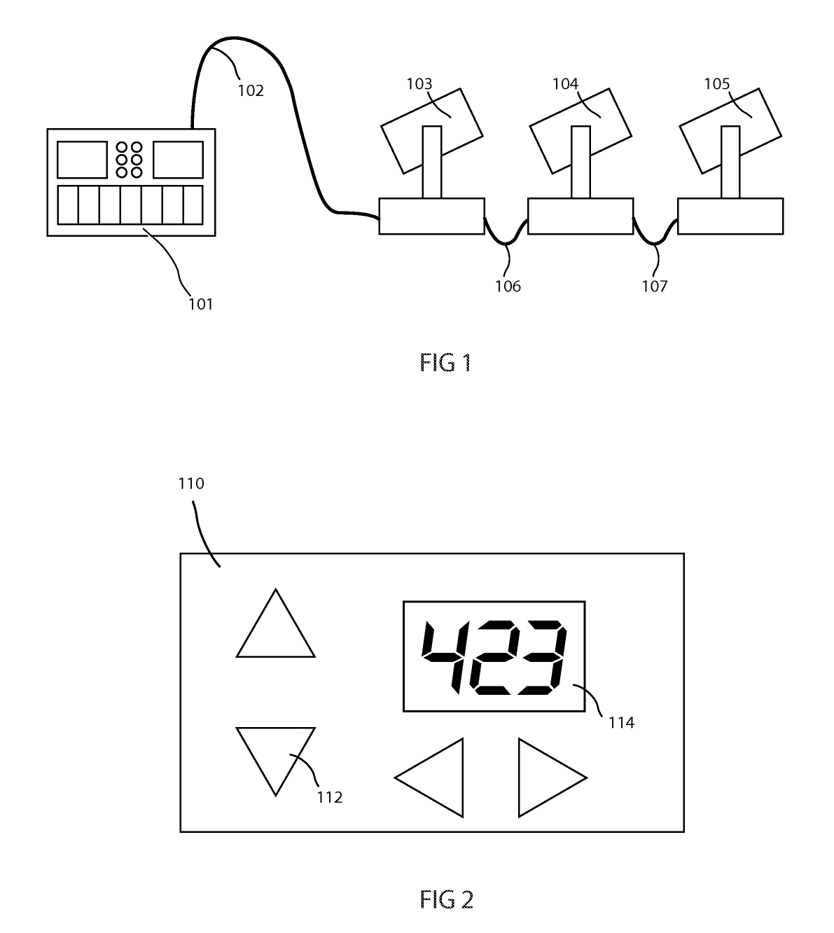

### DETAILED DESCRIPTION OF THE INVENTION

Preferred embodiments of the present invention are illustrated in the FIGUREs, like numerals being used to refer to like and corresponding parts of the various drawings.

The present invention generally relates to an automated luminaire, specifically to the display and display control system within such a luminaire and discloses means to provide simple and reconfigurable access to utilize and interrogate the operational parameters of the luminaire and that further tracks and permanently stores operational, service and event data for recall and investigation at any time.

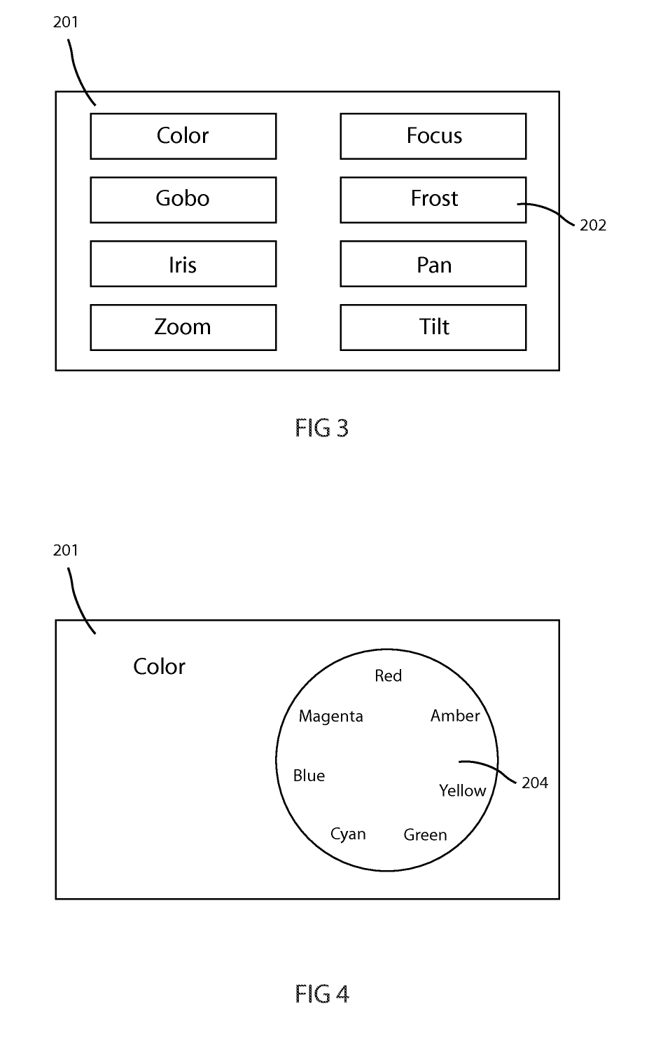

FIG. 3 illustrates a display of an embodiment of the invention. Instead of utilizing physical push buttons and an alphanumeric display as in the prior art display 201 is a high resolution graphic display capable of showing any desired graphics or characters. Further the display is fitted with a touch panel so that no external push buttons are required. In operation any area or feature of the display 202 may be configured to behave as a touch sensitive area to select or interrogate features. This type of display is inherently reconfigurable, reprogrammable and flexible to accommodate any future enhancements desired by the luminaire manufacturer. In FIG. 3 eight areas 202 of the screen 201 have been configured to act as selectable touch buttons to select one of eight features or sub-menus. The touch panel may be a resistive touch panel, a capacitive touch panel or other touch panel technology as well known in the art. In further embodiments the display may have external physical push buttons as well as the touch panel to provide immediate access to functions that are always required. The physical push buttons may cooperate with the touch panel and display in a coordinated manner.

FIG. 4 illustrates a further display of an embodiment of the invention. In this figure the display 201 is showing a color map 204 which contains a representation of all the possible colors that the luminaire is capable of producing in a graphic layout. Note that this may be just a colored graphic as opposed to the text labels illustrated here. By touching the color map at the desired point the luminaire may change to the selected color. This operation is much simpler and more intuitive than the prior art method of controlling the individual color parameters such as Red, Green, Blue levels or Cyan, Magenta, Yellow levels independently using up/down push buttons.

FIG. 5 illustrates a further display of an embodiment of the invention. In this figure the display 201 is showing all the patterns or gobos that are mounted on one of the gobo wheels 208 of the luminaire. One of the gobos 210 may be selected by touching its image and an enlarged image of the gobo 206 may then be displayed. The luminaire may also change to the selected gobo. The wheel may be rotated by touching and dragging the graphic gobo wheel 208. The physical gobos used in the luminaire may be interchangeable and an aspect of the invention is the ability to upload new graphic images to the luminaire such that the images displayed on the displayed wheel 208 match those on the physical gobo wheel. Such data may be transferred to the luminaire by means selected from a list including but not limited to a DMX512 interface, an ethernet interface, a RDM interface, a USB interface, an Infra red interface an RS485 interface, an RS232 interface, a Wi-Fi interface, a Zigbee interface, an RFID interface, and other data transmission means well known in the art.

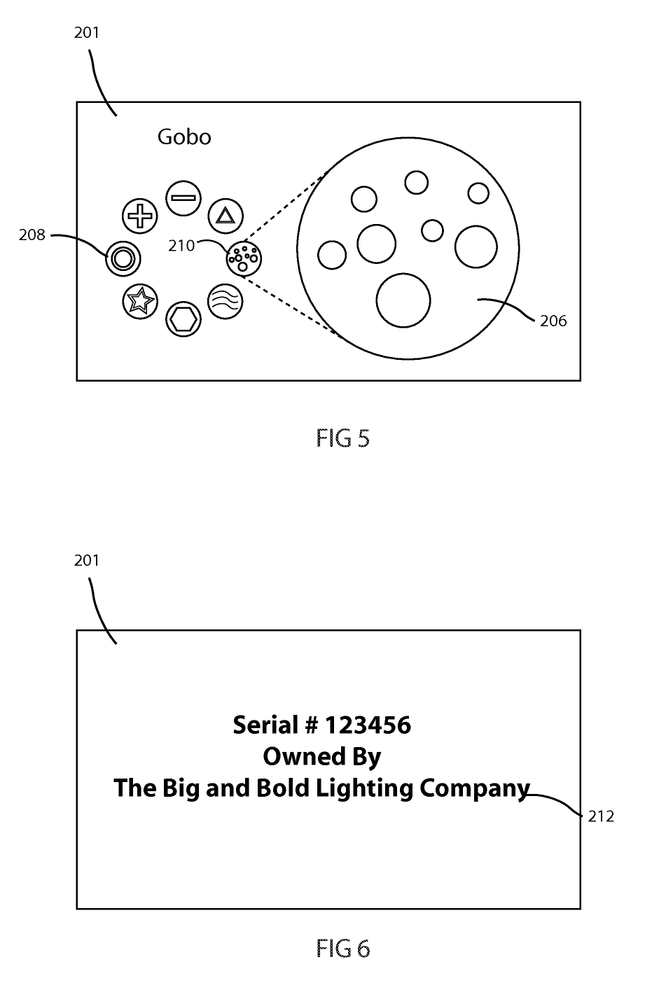

FIG. 6 illustrates a further display of an embodiment of the invention. In this figure the display 201 is showing information as to the serial number and owner 212 of the luminaire. This is particularly useful to a rental company as a means to establish identity and ownership of the luminaire. An aspect of the invention is the means to enter this information in a secure means utilizing a password so that it cannot be altered by a user. The display may include a graphic image of the logotype or other relevant graphic image of the owner.

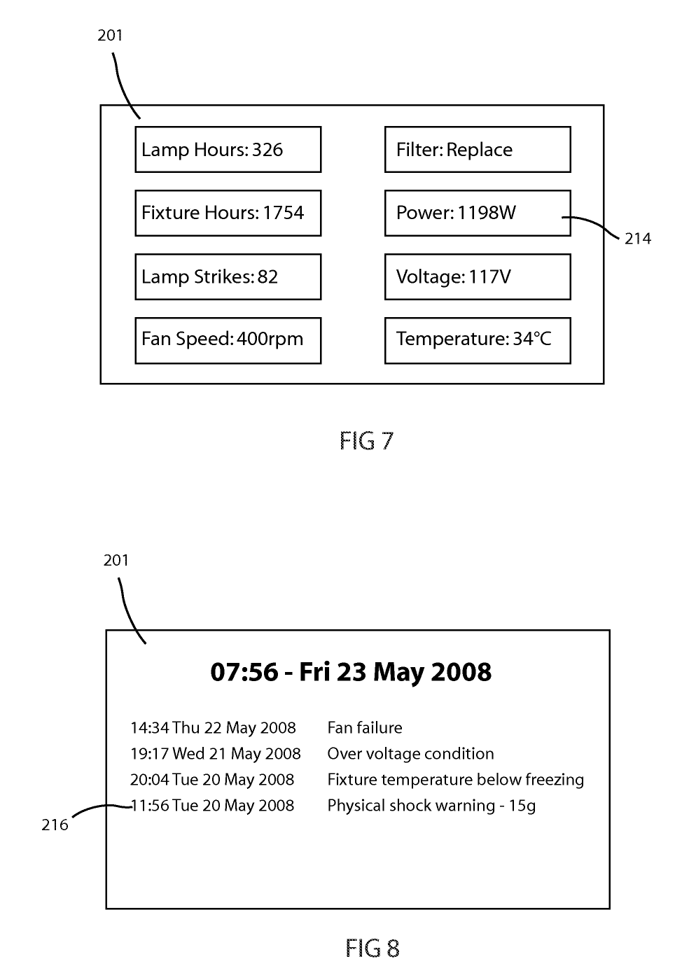

FIG. 7 illustrates a further display of an embodiment of the invention. In this figure the display 201 is showing live information relating to operational parameters of the luminaire. Information displayed 214 may relate to a list including but not restricted to: Lamp hours, fixture hours, lamp strikes, fan speeds, luminaire power consumption, luminaire voltage, luminaire current, luminaire power factor, ambient temperature, electronics temperature, lamp temperature, motor temperature, optical enclosure temperature, power supply temperature, air filter condition, air pressure, humidity, motor speeds, DMX512 values, acceleration for physical shock measurement, failure warnings and other parameters well known in the art.

FIG. 8 illustrates a further display of an embodiment of the invention. In this figure the display 201 is showing logged information 216 relating to operational events, diagnostics, failures and other data relevant to the usage, service and maintenance of such a luminaire. These events may be permanently stored in non-volatile memory such that they can be interrogated and retrieved at any time in the future. The display system may contain a real time clock such that these events may be logged with a date and time stamp showing when the event occurred.

The operational and diagnostic logging data illustrated in FIG. 8 may be collected and stored in the luminaire for later interrogation by the user, service facility or owner. This data may be viewed interactively on the screen and/or uploaded to an external diagnostic computer. The data may be transferred to the diagnostic computer by means selected from a list including but not limited to a DMX512 interface, an ethernet interface, a RDM interface, a USB interface, an Infra red interface an RS485 interface, an RS232 interface, a Wi-Fi interface, a Zigbee interface, an RFID interface, and other data transmission means well known in the art.

In a further embodiment the luminaire may be connected directly to the internet and a remote facility or service center may access the luminaire for retrieval of the operational and diagnostic data. Such access may be protected via password protection or other security means.

In a further embodiment the display system is fitted with a battery or other power source such that diagnostic data can be accumulated when the luminaire is disconnected form the mains power supply. For example the luminaire may accumulate data relating to acceleration of the luminaire from internal accelerometers as a warning of physical shock imparted during shipping or transportation. In another example the luminaire may log that it has been stored at low temperatures and the lamp and lubricants may require time to warm up before operating. The battery system may also allows setting of operational parameters such as the DMX512 address as the luminaire is being installed but before power is connected and available.

The display system may be fitted with a single physical push button to allow activation of the display when it is operating on battery power.

The luminaire may be installed in multiple orientations and consequently the display may be upside down or in any other orientation. In a further embodiment of the invention the display will reorient the displayed image so as to always provide a correctly oriented result. This reorientation may be automatic through the input from accelerometers or tilt switches or may be controlled by the user though controls on the display itself

The display may be fitted with a protective cover which may be transparent to protect the display in use and shipping.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

1. An automated luminaire display control system where the system monitors and logs diagnostic and operational events which can be accessed by the user.

2. The display control system of claim 1 wherein the user can access the log(s) via an onboard display.

3. The display control system of claim 1 where the event log(s) can be transferred to a diagnostic system.

4. The display control system of claim 3 where the transfer is over a global or regional network to a remote site or service station.

5. The display control system of claim 3 where the luminaire enclosed in a road case and the transfer does not require opening the road case.

6. The display control system of claim 5 where the transfer is wireless.

7. The display control system of claim 1 wherein the events may include:
subsystem failures, over voltage conditions, passage of temperature thresholds, physical shock, lamp strikes.

8. The display control system of claim 7 which incorporates a real time clock and the events can be logged with a date and time stamp.

9. The display control system of claim 7 also stores information which may include non-event information such as: serial number, owner identification, fixture usage time, lamp usage time, battery status, filter status.

10. The display control system of claim 2 where the onboard display is a touch screen display that displays graphical information in multiple alternative orientations.

11. An automated luminaire display control system where:
the system stores bibliographic information concerning the automated luminaire;
a user can access the bibliographic information through the display control system;
a user can change the bibliographic information through the display control system;
and access and/or the ability to change the bibliographic information is password protected.

12. The display control system of claim 11 wherein the user can access the log(s) via an onboard display.

13. The display control system of claim 11 where the event log(s) can be transferred to a diagnostic system.

14. The display control system of claim 13 where the transfer is over a global or regional network to a remote site or service station.

15. The display control system of claim 13 where the luminaire is stored in a road case and the transfer does not require opening the road case.

16. The display control system of claim 15 where the transfer is wireless.

17. The display control system of claim 11 wherein the events may include:
subsystem failures, over voltage conditions, passage of temperature thresholds, physical shock, lamp strikes.

18. The display control system of claim 17 which incorporates a real time clock and the events can be logged with a date and time stamp.

19. The display control system of claim 17 also stores information which may include non-event information such as: serial number, owner identification, fixture usage time, lamp usage time, battery status, filter status.

20. The display control system of claim 12 where the onboard display is a touch screen display that displays graphical information in multiple alternative orientations.

21. The display control system of claim 20 where the display includes a graphical representation of the gobo patterns installed in luminaire and replacement patterns can be uploaded to replace representations of gobo patterns which are replaced.

22. The display control system of claim 21 where the display includes a graphical representation of a color map representing the installed or possible color which can be projected by the luminaire.

23. The display control system of claim 20 where manipulation of the graphical information on the onboard display can be used to determine light output of the luminaire.
